(19) United States
(12) Patent Application Publication
(10) Pub. No.: US 2011/0025662 A1
(43) Pub. Date: Feb. 3, 2011

(54) TIMING CONTROLLER AND LIQUID DISPLAY DEVICE

(75) Inventor: Chi-Ting Huang, Tainan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HIMAX TECHNOLOGIES LIMITED, Tainan County (TW)

(21) Appl. No.: 12/533,069

(22) Filed: Jul. 31, 2009

(51) Int. Cl. G09G 5/00; G09G 3/36

(52) U.S. Cl. 345/208; 345/90

(57) ABSTRACT

An embodiment of the invention provides a timing controller. The timing controller comprises a frequency detector, a signal generator and a multiplexer. The frequency detector receives a reference clock signal and an input clock signal to generate a decision signal. The signal generator generates a first signal and a second signal. The multiplexer receives and outputs one of the first signal and the second signal according to the decision signal.

### BACKGROUND OF THE INVENTION

1. Field of the Invention

The invention relates to a timing controller, and more particularly to a timing controller capable of adjusting its timing signal.

2. Description of the Related Art

A liquid crystal display (LCD) apparatus generally includes two substrates, each having an electrode formed on an inner surface thereof, and a liquid crystal layer interposed between the two substrates. In the LCD apparatus, a voltage is applied to the electrodes to re-align liquid crystal molecules and control an amount of light transmitted through the liquid crystal layer, thereby obtaining desired images.

The refresh rate of the LCD apparatus may be kept at a high rate, but there is no need for the LCD to operate at such a speed if the user is running an application that does not require fast refresh rate. Dynamic refresh rate switching (DRRS) is applied to dynamically reduce the LCD panel's refresh rate when the system detects that the user is running applications that do not benefit from a high refresh rate, like typing a text document for example.

Furthermore, the dynamic refresh rate switching technology can save the power consumption of the electronic devices and extends the using time of the electronic devices, especially to the portable electronic devices, such as laptop, PDA or others. Compared with conventional design, the refresh rate of monitor is fixed unless user resets the refresh rate. In other words, the conventional design, the refresh rate of monitor is not auto adjusted, and this may waste too much power of the electronic device.

### BRIEF SUMMARY OF THE INVENTION

An embodiment of the invention provides a timing controller for receiving display signals based on an input clock signal. The timing controller comprises a frequency detector, a signal generator and a multiplexer. The frequency detector detects a status of the input clock signal to generate a select signal. The signal generator generates a first signal and a second signal, and the first signal and the second signal are one control signal with different attributes. The multiplexer receives and outputs one of the first signal and the second signal according to the decision signal.

Another embodiment of the invention provides a liquid crystal display. The liquid crystal display comprises a source driver, a gate driver and a timing controller. The timing controller controls the source driver and the gate driver. The timing controller comprises a frequency detector, a signal generator and a multiplexer. The frequency detector receives a reference clock signal and an input clock signal to generate a decision signal. The signal generator generates a first signal and a second signal. The multiplexer receives and outputs one of the first signal and the second signal according to the decision signal.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a signal waveform diagram for a liquid crystal display.

FIG. 2 shows a switch circuit according to an embodiment of the invention.

FIG. 3 is an embodiment of the frequency detector according to the invention.

FIG. 4 is an embodiment of a liquid crystal display according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

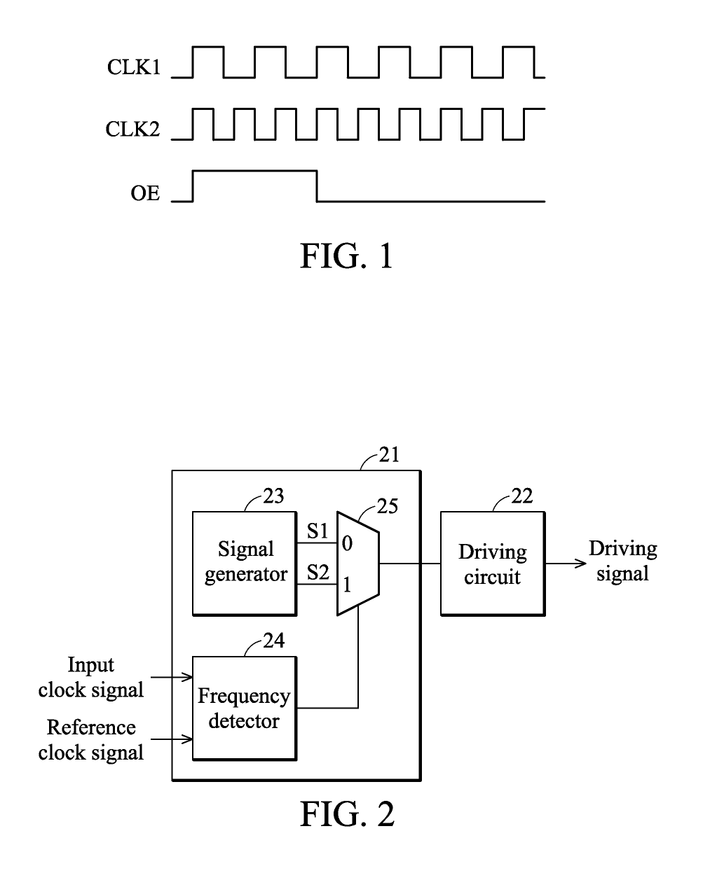

FIG. 1 shows a signal waveform diagram for a liquid crystal display. A signal OE is used to turn off the gate driver and is determined according to the clock signals CLK1 or CLK 2. Since the signal OE is determined according to a predetermined number of cycles of clock signals CLK1 or CLK 2 and the pulse width of a high voltage level signal OE has to exceed a lower threshold, the pulse width of the high voltage level signal OE may not be sufficient if the frequency of the selected clock signal is higher than usual.

FIG. 2 shows a control signal generator according to an embodiment of the invention. The control signal generator 21 provides at least one control signal, whose attribute is determined based on an input clock signal. The driving circuit 22 receives the control signals and outputs driving signals to drive a display, such as a flat panel display, a liquid crystal display, an OLED display or other type of displays. The control signal generator 21 includes a frequency detector 24, a signal generator 23 and a multiplexer 25. The frequency detector 24 detects the status of the input clock signal for outputting a select signal to the multiplexer 25. More specifically, the frequency detector 24 detects the frequency change of the input clock in one embodiment. The frequency detector 24 may detect the status of the input clock signal by detecting a frequency change of the input clock signal. In another embodiment, the frequency detector 24 may detects the frequency change of the input clock signal by comparing the input clock signal with a reference clock signal. Signal generator 23 generates a first signal S1 and a second signal S2 to the multiplexer 25 and the multiplexer 25 selects one of the first signal S1 and the second signal S2 according to the select signal. In one embodiment, the first signal S1 and the second signal S2 are output-enable signals OE with different attributes, such as with different duration time. In another example, the first signal S1 and the second signal S2 may be other control signals such as an STV (start pulse vertical) signal, a CPV (clock pulse vertical) signal or the like for the driving circuit 22.

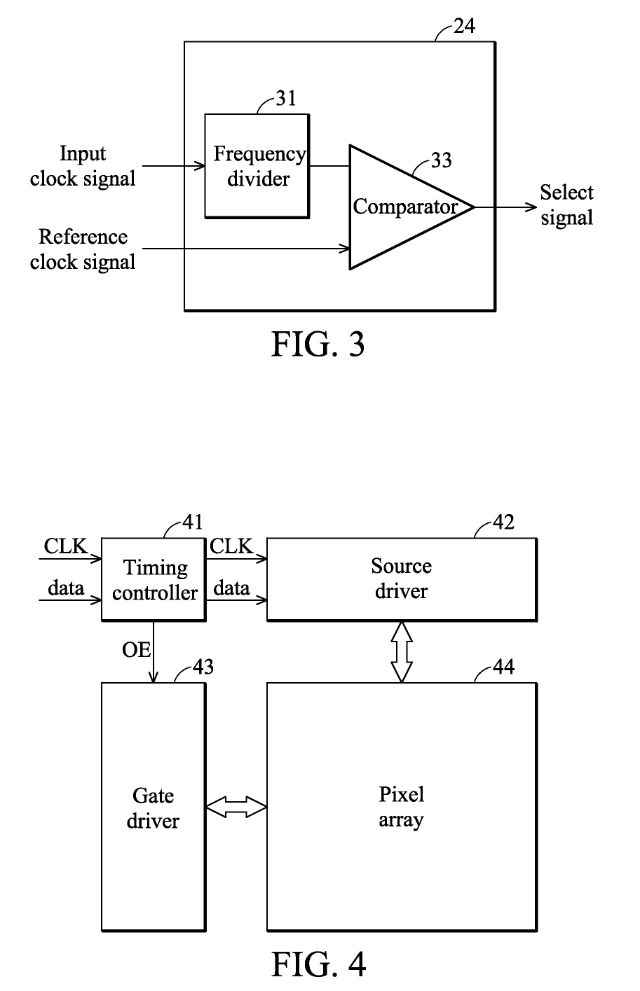

In one embodiment, the frequency detector 24 detects the frequency change of the input clock signal by comparing the input clock signal with a reference clock signal. Please refer to FIG. 3. FIG. 3 is an embodiment of the frequency detector according to the invention. The frequency divider 31 receives and divides the input clock signal by a first value. The reference clock signal is directly transmitted to the comparator 33. If the frequency difference between the frequency of input clock signal, f1, and the frequency of the reference clock signal, f2, is larger than (−¼) f1, the frequency detector 24 determines that the input clock signal is a high frequency clock signal In another embodiment, if the frequency difference between the frequency of the input clock signal, f1, and the frequency of the reference clock signal, f2, is smaller than (−¼) f2, the frequency detector 24 determines that the input clock signal is a low frequency clock signal.

To increase the sensitivity of the frequency detector 24, an offset can be applied to the detector for detecting smaller frequency differences by the frequency detector 24. Assuming the multiplexer 25 initially outputs the second signal S2 to the driving circuit 22, the frequency of the input clock signal is f1, the frequency of the reference clock signal is f2 and the offset is fo, the frequency detector 24 will determine that the input clock signal is a high frequency clock signal when f1>f2+fo, and the multiplexer 25 will output the first signal S1 to the driving circuit 22 if the condition occurs. If the frequency f1 is not larger than the sum of frequencies f2 and fo, the multiplexer 25 still outputs the second signal S2 to the driving circuit 22.

Assuming the multiplexer 25 initially outputs the first signal S1 to the driving circuit 22, the frequency detector 24 determines that the input clock signal will change to be a low frequency clock signal when f1<f2−fo, and the multiplexer 25 will output the second signal S2 to the driving circuit 22 if the condition occurs. If the frequency f2 is not larger than the sum of frequencies f1 and fo, the multiplexer 25 still outputs the first signal S1 to the driving circuit 22.

FIG. 4 is an embodiment of a liquid crystal display according to the invention. The pixel array 44 is driven by the source driver 42 and the gate driver 43 to show images. The timing controller 41 receives and transmits the clock signal CLK and data to the source driver 42. The timing controller further transmits the corresponding control signal OE to the gate driver 43 according to the frequency of the clock signal CLK. For the frequency detection mechanism and generation of the control signal OE, reference may be made to the descriptions related to FIGS. 2 and 3. It is noted that the present disclosure is illustrated with only minimal elements and signals required by a liquid crystal display, and other elements are not described here for briefly because they are known by those skilled in the art.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A timing controller for receiving display signals based on an input clock signal, comprising:
a frequency detector detecting a status of the input clock signal to generate a select signal;
a signal generator to generate a first signal and a second signal, and the first signal and the second signal are one control signal with different attributes; and
a multiplexer receiving and outputting one of the first signal and the second signal according to the decision signal.

2. The timing controller as claimed in claim 1, wherein the frequency detector detects the status of the input clock signal by detecting a frequency change of the input clock signal.

3. The timing controller as claimed in claim 1, wherein the frequency detector detects the frequency change of the input clock signal by comparing the input clock signal with a reference clock signal.

4. The controller as claimed in claim 1, wherein when a frequency difference between the input clock signal and the reference clock signal is smaller than a predetermined value, the multiplexer selects and outputs the first signal.

5. The controller as claimed in claim 1, wherein when a frequency difference between the input clock signal and the reference clock signal is larger than a predetermined value and the frequency of the input clock signal is larger than the frequency of the reference clock signal, the multiplexer selects and outputs the second signal.

6. The controller as claimed in claim 1, wherein when a frequency difference between the input clock signal and the reference clock signal is larger than a predetermined value and the frequency of the input clock signal is smaller than the frequency of the reference clock signal, the multiplexer selects and outputs the first signal.

7. The controller as claimed in claim 1, further comprising:
a first frequency divider receiving and frequency dividing the input clocks signal; and
a second frequency divider receiving and frequency dividing the reference clocks signal.

8. The controller as claimed in claim 1, wherein the frequency detector further comprises a comparator to compare the frequency of the input clock signal with the frequency of the reference clock signal.

9. The controller as claimed in claim 1, wherein if the frequency of the input clock signal and the frequency of the reference clock signal do not meet a predetermined condition, the multiplexer maintains its output signal.

10. A liquid crystal display, comprising:
a source driver;
a gate driver; and
a timing controller to control the source driver and the gate driver, comprising:
a frequency detector receiving a reference clock signal and an input clock signal to generate a decision signal;
a signal generator to generate a first signal and a second signal; and
a multiplexer receiving and outputting one of the first signal and the second signal according to the decision signal.

11. The display as claimed in claim 10, wherein when a frequency difference between the input clock signal and the reference clock signal is smaller than a predetermined value, the multiplexer selects and outputs the first signal.

12. The display as claimed in claim 10, wherein when a frequency difference between the input clock signal and the reference clock signal is larger than a predetermined value and the frequency of the input clock signal is larger than the frequency of the reference clock signal, the multiplexer selects and outputs the second signal.

13. The display as claimed in claim 10, wherein when a frequency difference between the input clock signal and the reference clock signal is larger than a predetermined value and the frequency of the input clock signal is smaller than the frequency of the reference clock signal, the multiplexer selects and outputs the first signal.

14. The display as claimed in claim 10, wherein the timing controller further comprises:
a first frequency divider receiving and frequency dividing the input clocks signal; and
a second frequency divider receiving and frequency dividing the reference clocks signal.

15. The display as claimed in claim 10, wherein the frequency detector further comprises a comparator to compare the frequency of the input clock signal with the frequency of the reference clock signal.

16. The display as claimed in claim 10, wherein the frequency detector further comprises a comparator to compare the frequency of the input clock signal with the frequency of the reference clock signal.
